(19) United States
(12) Patent Application Publication
(10) Pub. No.: US 2025/0158471 A1
(43) Pub. Date: May 15, 2025

(54) STATOR, SLOT-CLOSURE MEANS, AND TEMPERATURE-MEASURING ARRANGEMENT

(71) Applicant: Schaeffler Technologies AG & Co. KG, Herzogenaurach (DE)

(72) Inventor: Jens Langanki, Ottersweier (DE)

(21) Appl. No.: 18/839,324

(22) PCT Filed: Jan. 24, 2023
(86) PCT No.: PCT/DE2023/100052

§ 371 Date: Aug. 16, 2024

(30) Foreign Application Priority Data
Feb. 18, 2022 (DE) 10 2022 103 862.9

(51) Int. Cl. H02K 3/487; H02K 1/16; H02K 11/25

(52) U.S. Cl. CPC H02K 3/487; H02K 1/165; H02K 11/25

(57) ABSTRACT

The invention relates to a stator (1) for an electric machine (2), comprising a stator body (3) having a plurality of circumferentially distributed stator teeth (4) and stator slots (5) formed between the stator teeth (4) and extending in the axial direction through the stator body (3), wherein: stator windings (6) are arranged in the stator slots (5) and the stator slots (5) comprise, along their radial extension at their radially outer end, a slot base (7) and, at their radially inner end, a slot opening (8); at least one of each of the slot openings (8) is closed by a slot-closure means (9) such that the stator windings (6) are held in the stator slot (5); a temperature sensor (10) is arranged in and/or on at least one of the slot-closure means and the temperature sensor (10) comprises at least one electrical conductor (12), by means of which the temperature sensor (10) can be coupled to a control unit (17); the electrical conductor (12) extends substantially axially on and/or through the slot-closure means (9) and projects out of the slot-closure means (9); the slot-closure means (9) provided with a temperature sensor (10) protrudes axially from a winding head (13) formed by the stator windings (6).

### CROSS-REFERENCE TO RELATED APPLICATION

The present application is the U.S. National Phase of PCT Patent Application Number PCT/DE2023/100052, filed on Jan. 24, 2023, which claims priority to German Patent Application Number 10 2022 103 862.9, filed Feb. 18, 2022, the entire disclosures of which are incorporated by reference herein.

### TECHNICAL FIELD

The present disclosure relates to a stator for an electric machine, comprising a stator body having a plurality of stator teeth arranged in a circumferentially distributed manner and stator slots formed between the stator teeth and extending in the axial direction through the stator body, wherein stator windings are arranged in the stator slots and the stator slots have, along their radial extension at their radially outer end, a slot base and, at their radially inner end, a slot opening, or the stator slots have, along their radial extension at their radially inner end, a slot base and, at their radially outer end, a slot opening, wherein at least one of the slot openings is closed by a respective slot-closure means in each case such that the stator windings are held in the stator slot, wherein a temperature sensor is arranged in and/or on at least one of the slot-closure means and the temperature sensor has at least one electrical conductor, by means of which the temperature sensor can be coupled to a control unit, wherein the electrical conductor extends substantially axially on and/or through the slot-closure means and projects out of the slot-closure means. The disclosure further relates to a slot-closure means and a temperature measuring arrangement.

### BACKGROUND

Electric motors are increasingly being used to drive motor vehicles in order to create alternatives to internal combustion engines that require fossil fuels. Significant efforts have already been made to improve the suitability of electric drives for everyday use and also to be able to offer users the driving comfort they are accustomed to.

A detailed description of an electric drive can be found in an article in the German automotive magazine ATZ, volume 113, 05/2011, pages 10-15 by Erik Schneider, Frank Fickl, Bernd Cebulski and Jens Liebold with the title: Highly Integrative and Flexible Electric Drive Unit for Electric Vehicles. This article describes a drive unit for an axle of a vehicle, which comprises an electric motor that is arranged to be concentric and coaxial with a bevel gear differential, wherein a shiftable 2-speed planetary gear set is arranged in the power train between the electric motor and the bevel gear differential and is also positioned to be coaxial with the electric motor or the bevel gear differential or spur gear differential. The drive unit is very compact and allows for a good compromise between climbing ability, acceleration and energy consumption due to the shiftable 2-speed planetary gear set. Such drive units are also referred to as e-axles or electrically operable drive trains.

In addition to purely electrically operated drive trains, hybrid drive trains are also known. Such drive trains of a hybrid vehicle usually comprise a combination of an internal combustion engine and an electric motor, and enable, for example in urban areas, a purely electric mode of operation while at the same time permitting both sufficient range and availability, in particular when driving cross-country. In addition, it is also possible to drive the internal combustion engine and the electric motor at the same time in certain operating situations.

In the development of electric machines intended for e-axles or hybrid modules, there is a continuing need to increase their power densities, so the cooling of electric machines required for this is growing in importance. Owing to the necessary cooling capacities, hydraulic fluids such as cooling oils have become established in most concepts for the removal of heat from the thermally loaded regions of an electric machine.

For the effective thermal management of such an electric machine, it is necessary to determine different temperatures at different positions of the electric machine. The temperature should be measured as accurately as possible, in particular at expected thermal hot spots, in order to avoid a local or general thermal overload of the electric machine by controlling the electric machine and/or its cooling system.

There is also an ongoing need to be able to manufacture electric machines for the automotive industry in a particularly cost-effective and assembly-friendly manner.

### SUMMARY

It is therefore the object of the disclosure to provide a stator for an electric machine which reduces or completely eliminates the disadvantages known from the prior art and enables a cost-effective and accurate temperature measurement in thermally stressed regions of the stator, wherein this temperature measurement solution is also designed to be particularly assembly-friendly. It is further the object of the disclosure to realize an improved slot-closure means and an improved temperature measuring arrangement for a stator of an electric machine.

This object is achieved by a stator for an electric machine, comprising a stator body having a plurality of stator teeth arranged in a circumferentially distributed manner and stator slots formed between the stator teeth and extending in the axial direction through the stator body, wherein stator windings are arranged in the stator slots and the stator slots have, along their radial extension at their radially outer end, a slot base and, at their radially inner end, a slot opening, or the stator slots have, along their radial extension at their radially inner end, a slot base and, at their radially outer end, a slot opening, wherein at least one of the slot openings is closed by a respective slot-closure means in each case such that the stator windings are held in the stator slot, wherein a temperature sensor is arranged in and/or on at least one of the slot-closure means and the temperature sensor has at least one electrical conductor, by means of which the temperature sensor can be coupled to a control unit, wherein the electrical conductor extends substantially axially on and/or through the slot-closure means and projects out of the slot-closure means, wherein the slot-closure means provided with a temperature sensor protrudes axially from a winding head formed by the stator windings.

This provides the advantage that the slot-closure means, in which the temperature sensor is arranged, is axially extended such that it is slightly raised above the winding head. This enables a particularly simple and intuitive assembly or intuitive connection of the temperature sensor, as the corresponding connection on the protruding slot-closure means practically “jumps out” at the person carrying out the assembly and is therefore very easy to visually recognize. This can shorten the assembly time and increase the assembly safety of the temperature sensor.

In addition, the advantage can be achieved that, on the one hand, the assembly effort for the temperature sensor can be kept to a minimum by integrating it in or on the slot-closure means, which can also have a positive influence on the assembly costs. It is also possible to place the temperature sensor very close to possible thermal hot spots, which enables a fast and precise response of the sensor and allows for high open-loop and closed-loop control dynamics. Furthermore, corresponding motors can also be very easily fitted with corresponding integrated temperature sensors for testing purposes and their thermal properties can be determined in a simple and reliable manner.

It is to be understood that a plurality of electrical conductors can also extend on and/or through the slot-closure means. It is particularly preferred that two electrical conductors extend on and/or through the slot-closure means. Most preferably, a temperature sensor has two electrical conductors. It may also be preferable to provide at least one second temperature sensor in a slot-closure means in order to form a redundant temperature measuring system and/or to be able to take a temperature measurement at two different points in the stator. In this context, it is preferred that each temperature sensor has two electrical conductors.

An electrical conductor can be, for example, a conductor track or a cable.

The stator according to the disclosure is preferably designed for use in a radial flux machine. A stator for a radial flux machine usually has a cylindrical structure and generally consists of electrical laminations that are electrically insulated from one another and are structured in layers and packaged to form laminated cores. Distributed around the circumference, slots are embedded into the electrical lamination substantially extending parallel to the rotor shaft, which receive the stator winding or parts of the stator winding.

The stator can also be formed in a corresponding manner for an electric machine configured as an external rotor or internal rotor.

Stator windings are embedded in the stator slots of the stator according to the disclosure. A stator winding is an electrically conductive conductor whose length extension is much greater than its diameter. The stator winding can generally have any cross-sectional shape. Rectangular cross-sectional shapes are preferred, as these allow for high packing densities and consequently high power densities to be achieved. Particularly preferably, a stator winding is formed of copper. Preferably, a stator winding has an insulation. To insulate the stator winding, for example, mica paper, which for mechanical reasons can be reinforced by a glass fabric bearer, may be wound in tape form around one or more stator windings, which are impregnated by means of a curing resin. In principle, it is also possible to use a curable varnish layer without a mica paper to insulate a stator winding.

The stator according to the disclosure further has a stator body. The stator body can be formed in one or more parts, in particular in a segmented manner. A single-part stator body is characterized by the fact that the entire stator body is formed as a single part, as viewed circumferentially. In this regard, the stator body is usually formed from a plurality of stacked electrical laminations, wherein each of the electrical laminations is closed to form a circular ring. A segmented stator body is characterized by the fact that it is made up of individual stator segment parts. In this regard, the stator body can be made up of individual stator teeth or stator tooth groups, wherein each individual stator tooth or each individual stator tooth group can be formed from a plurality of stacked laminated electrical sheets, wherein each of the electrical sheets is formed as a stator segment lamination part.

The stator body is preferably formed from one or more laminated stator cores. A laminated stator core is understood to mean a plurality of laminated individual sheets or stator laminations, which are generally made from electrical metal sheets and are stacked and packaged one on top of the other to form a stack or “laminated stator core”. The individual laminations can then remain held together in the laminated core by gluing, welding, or screwing.

The stator teeth of the stator are preferably formed in the stator body. Stator teeth are components of the stator body that are designed as circumferentially spaced, tooth-like parts of the stator body directed radially inwards (internal rotor) or outwards (external rotor) and between the free ends of which and a rotor body an air gap for the magnetic field is formed. The existing gap between the rotor and the stator is referred to as the air gap. In a radial flux machine, this is a substantially annular gap with a radial width that corresponds to the distance between the rotor body and the stator body.

The stator is intended in particular for use in an electric machine within a drive train of a motor vehicle. The electric machine is intended in particular for use within a drive train of a hybrid or fully electrically driven motor vehicle.

In particular, the electric machine is dimensioned such that vehicle speeds of more than 50 km/h, preferably more than 80 km/h and in particular more than 100 km/h can be achieved. The electric machine particularly preferably has an output of more than 30 KW, preferably more than 50 KW and in particular more than 70 kW. Furthermore, it is preferred that the electric machine provides speeds greater than 5,000 rpm, particularly preferably greater than 10,000 rpm, very particularly preferably greater than 12,500 rpm.

For the purposes of this application, a temperature sensor is an electrical or electronic component that supplies an electrical signal as a measure of the temperature acting on the temperature sensor. For example, a temperature sensor can be selected from the group of thermocouples, NTC thermistor temperature sensors, PTC thermistor temperature sensors, semiconductor temperature sensors, ferromagnetic temperature sensors, pyroelectric temperature sensors, fiber optic temperature sensors and/or pyrometers.

The temperature sensor is preferably configured as an NTC thermistor temperature sensor, which is also referred to as an NTC resistor or NTC thermistor (negative temperature coefficient thermistor).

The temperature sensor can be connected to the slot-closure means in a form-fitting and/or force-fitting and/or materially bonded manner, in particular also non-releasably connected. For example, form-fit means can be provided on the slot-closure means, which effect a form-fitting fixation of the temperature sensor on and/or in the slot-closure means. In this context, it is particularly preferable to design the form-fit means as a clip connection, into which the temperature sensor can be clipped and is held in a captive manner. Furthermore, it is preferred in this context that the form-fit means are formed monolithically with the slot-closure means, for example via a plastic injection molding process.

Preferably, the slot-closure means is made of a material with a thermal conductivity of greater than 0.1 W/(m*K), preferably greater than 1.0 W/(m*K), most preferably greater than 10 W (m*K), which makes it possible to realize particularly short response times for the temperature sensor.

According to an advantageous embodiment of the disclosure, the slot-closure means can be made of plastic and the temperature sensor can be surrounded by plastic at least in sections, preferably completely. The advantage of this embodiment is that the temperature sensor is protected against mechanical and/or chemical influences. In principle, however, it would also be conceivable for the temperature sensor to be positioned open in the slot-closure means at least on the side facing the slot base of the stator slot and thus, for example, to make direct contact with a cooling oil located in the stator slot and/or a stator winding.

According to a further preferred further development of the disclosure, the slot-closure means can be manufactured via a plastic injection molding process in which the temperature sensor is inserted into a corresponding injection mold prior to injection molding, which is particularly advantageous in terms of production engineering.

Furthermore, according to a likewise advantageous embodiment of the invention disclosure, the slot-closure means can have a sensor slot, into which the temperature sensor is inserted and held in the sensor slot by means of a fixing material. The advantageous effect of this embodiment is that, for example, all slot-closure means used in a stator can be designed in the same way, wherein a temperature sensor is only inserted in the sensor slot or sensor slots for which slot-closure means a temperature measurement is to be carried out. The high proportion of identical parts can have a positive impact on manufacturing costs.

The sensor slot can be formed in particular on the surface of the slot-closure means facing the slot base. Furthermore, it is preferred that the sensor slot terminates at a distal end of the longitudinal extension of the slot-closure means.

According to a further particularly preferred embodiment of the disclosure, the slot-closure means can have a sensor channel which is circumferentially closed at least in sections, into which the temperature sensor is inserted and held in the sensor channel by means of a fixing material. For example, the sensor channel can be formed by a hole in the slot-closure means.

Furthermore, the disclosure can also be further developed in such a way that the fixing material is different from the material of the slot-closure means. Preferably, the fixing means is made of a material with a thermal conductivity of greater than 0.1 W/(m*K), preferably greater than 1.0 W/(m*K), most preferably greater than 10 W (m*K), which makes it possible to realize particularly short response times for the temperature sensor. Furthermore, the material of the slot-closure means can have a thermal conductivity that is different from the thermal conductivity of the fixing means. In particular, the material of the slot-closure means can preferably have a thermal conductivity that is lower than the thermal conductivity of the fixing means.

The fixing material can fill the sensor slot or the sensor channel completely or also only in sections. What is relevant here is that the fixing material fixes the temperature sensor and/or the cables connected to the temperature sensor in the sensor slot or the sensor channel. In a likewise preferred embodiment of the disclosure, the fixing material can be a potting compound, in particular a potting compound made of a plastic, and/or an adhesive. According to a further advantageous embodiment of the disclosure, the at least one electrical conductor can be fixed in and/or on the slot-closure means by means of a potting compound. This has the advantage that the electrical conductor and the temperature sensor can be potted together, which is particularly advantageous in terms of production engineering.

It may also be advantageous to further develop the disclosure in such a way that the fixing material is identical to the material of the slot-closure means, wherein the fixation of the temperature sensor in and/or on the slot-closure means is realized by means of a forming process applied to the slot-closure means. For example, it would be possible to locally heat and then form a slot-closure means in the region of the receptacle of the temperature sensor and/or the cable connected to the temperature sensor, wherein the material displacement at the slot-closure means causes the temperature sensor and/or the cable to be fixed. A suitable forming process for this would be, for example, caulking or bending.

According to a further preferred embodiment of the subject matter of the disclosure, the slot-closure means can preferably close the slot opening over the entire axial extension and the temperature sensor can be arranged in the axial extension approximately centrally on and/or in the slot-closure means. In this way, thermal hot spots that frequently occur in the center of the axial extension can be easily recognized. Furthermore, the axial positioning of the temperature sensor can be achieved in a particularly assembly-friendly and secure manner.

In principle, it would of course be possible for the slot-closure means not to extend completely over the entire axial extension of a stator slot, but to close it only in sections.

Finally, the disclosure can also be advantageously developed in such a way that the temperature sensor has a cable by means of which the temperature sensor can be coupled to a control unit, wherein the cable extends axially on and/or through the slot-closure means and projects out of the slot-closure means, whereby the temperature sensor can be connected to a control unit in an assembly-friendly manner after the slot-closure means has been inserted into the stator.

A control unit, as may be used in connection with the present disclosure, is used for the, in particular electronic, open-loop or closed-loop control of one or more technical systems of an electric machine, in particular an electric machine in a drive train of a motor vehicle. In particular, a control unit can be provided for the open-loop or closed-loop control of a cooling system of an electric machine.

A control unit has, in particular, a wired or wireless signal input for receiving, in particular electrical, signals, such as sensor signals, for example, preferably signals from a temperature sensor. Furthermore, a control unit likewise preferably has a wired or wireless signal output for the transmission of, in particular, electrical signals, for example to electrical actuators or electrical consumers of a motor vehicle.

Open-loop control operations and/or closed-loop control operations can be carried out within the control unit. It is very particularly preferable that the control unit comprises hardware that is designed to run software. The control unit preferably comprises at least one electronic processor for executing program sequences defined in software.

The control unit can also have one or more electronic memories in which the data contained in the signals transmitted to the control unit can be stored and read out again. Furthermore, the control unit can have one or more electronic memories in which data can be stored in a modifiable and/or non-modifiable manner.

A control unit can comprise a plurality of control devices which are arranged in particular spatially separate from one another in the motor vehicle. Control devices are also referred to as electronic control units (ECU) or electronic control modules (ECM) and preferably have electronic microcontrollers for carrying out computing operations for processing data, particularly preferably using software. The control devices can preferably be interconnected with one another such that a wired and/or wireless data exchange between control devices is made possible. In particular, it is also possible to interconnect the control devices with one another via bus systems present in the motor vehicle, such as a CAN bus or LIN bus for example.

The object of the disclosure is further achieved by a slot-closure means of a stator of an electric machine, wherein a temperature sensor is arranged in and/or on at least one of the slot-closure means for coupling with a control unit.

The slot-closure means can preferably also be formed using an additive manufacturing process. In this context, it is particularly preferred that the temperature sensor is also formed together with the slot-closure means in an additive manufacturing process. It is also particularly preferred that the electrical lines for connection to the control unit are also formed together with the slot-closure means and the temperature sensor in an additive manufacturing process.

In this context, the electrical lines can be connected in particular to an electrical connection device of the slot-closure means, wherein the electrical connection device is designed, for example, as an electrical coupling for accommodating a plug device. It is highly preferred that the connection device is formed together with the slot-closure means, the temperature sensor and the electrical lines using an additive manufacturing process.

An additive manufacturing process is often also referred to as a generative manufacturing process or a three-dimensional printing process (3D printing). The additive manufacturing process enables the slot-closure means, and preferably also the temperature sensor and/or the electrical lines and/or the electrical connection device, to be manufactured quickly and cost-effectively in a single work process, wherein manufacturing can be carried out in particular on the basis of computer-internal data models from shapeless or shape-neutral starting material by means of chemical and/or physical processes. An additive or generative method can

Finally, the object of the disclosure is also achieved by a temperature measuring arrangement for a stator of an electric machine comprising a control unit, a temperature sensor and a slot-closure means, wherein a temperature sensor is arranged in and/or on the slot-closure means for coupling with a control unit. This, in particular, makes it possible to provide a modular unit that can be pre-assembled for a wide variety of stators, for example.

According to a further preferred further development of the disclosure, the at least one electrical conductor can be designed as a cable. Most preferably, the temperature sensor has two cables.

Furthermore, according to a likewise advantageous embodiment of the disclosure, the cable may not have an electrically insulating sheath. On the one hand, this can save costs and, on the other hand, further simplify the assembly, as there is no need to strip the cable before or during assembly. The one or more cables of the temperature sensor are therefore preferably not sheathed and embedded as such into the slot-closure means. In this regard, it is also preferable to provide a partition in the slot-closure means, for example, which spatially separates non-insulated cables from one another.

According to a further particularly preferred embodiment of the disclosure, the slot-closure means can have a slot within which the at least one electrical conductor extends, which is preferred in terms of production engineering, since the insertion of the cable or cables into the slot can be safely performed and is easy to check visually.

Furthermore, the disclosure can also be further developed in such a way that the part of the at least one electrical conductor projecting out of the slot-closure means bears at least in sections against an outer lateral surface of the slot-closure means, which simplifies contacting by pushing a corresponding plug onto the slot-closure means. At one of the axial ends of the slot-closure means, the one or more cables emerging from the slot-closure means in the axial direction can therefore preferably be bent over and guided laterally on the outer lateral surface of the slot-closure means a short distance axially in the opposite direction.

In a likewise preferred embodiment of the disclosure, the lateral surface of the slot-closure means can be formed with a guide section for fixing the part of the at least one electrical conductor projecting out of the slot-closure means. The guide section can, for example, comprise a slot projecting into the lateral surface or a clamping element projecting out of the lateral surface, into which the electrical conductor can be clamped.

This ensures that the one or more electrical conductors assume a defined position on the lateral surface and cannot be inadvertently brought into electrical contact with one another, particularly when attaching a plug to the slot-closure means.

It may also be advantageous to further develop the disclosure in such a way that the part of the at least one electrical conductor projecting out of the slot-closure means can be contacted by means of a plug which can be attached to the slot-closure means, whereby assembly can be further improved due to the simple connection by means of attachment. In particular, the plug is electrically connected to the control unit. Particularly preferably, the plug and/or the slot-closure means has a sealing means by means of which the electrical contact region between the plug and the part of the at least one electrical conductor projecting out of the slot-closure means can be sealed off from the surroundings of the plug, in particular can be sealed in a liquid-tight manner.

When manufacturing the stator slot, a slot closing wedge with a temperature sensor is therefore inserted into a stator slot. After the stator has been completely manufactured and, if necessary, installed in a housing, the plug, which can be affixed to a cable, for example, is attached to the slot-closure means with the temperature sensor and thus the temperature sensor is contacted and connected to the control unit of the stator.

In order to always guarantee a contacting of the temperature sensor with the correct polarity, the slot-closure means and/or the plug can preferably have a poka-yoke feature, which only allows for the plug to be attached in a defined manner to the slot-closure means in a predefined position.

The disclosure is explained in more detail below with reference to drawings without limiting the general concept of the disclosure.

### BRIEF DESCRIPTION OF THE DRAWINGS

In the drawings:

FIG. 1 shows a schematic cross-sectional view of an electric machine,

FIG. 2 shows a schematic detailed view of a stator slot in a cross-sectional representation,

FIG. 3 shows a stator in a perspective view,

FIG. 4 shows a slot-closure means in a perspective view,

FIG. 5 shows a slot-closure means in a perspective view, and

FIG. 6 shows a slot-closure means with a plug in a perspective view.

### DETAILED DESCRIPTION

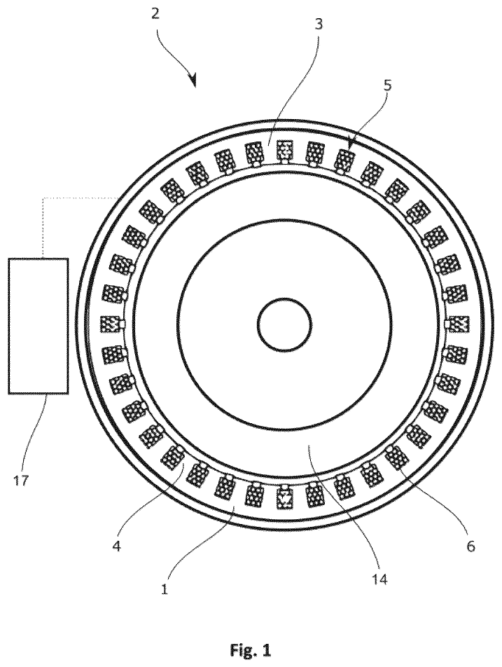

FIG. 1 shows a stator 1 of an electric machine 2, comprising a stator body 3 with a plurality of stator teeth 4 arranged in a circumferentially distributed manner and stator slots 5 formed between the stator teeth 4 and extending in the axial direction through the stator body 3. Stator windings 6 are arranged in the stator slots 5. The stator slots 5 have, along their radial extension at their radially outer end, a slot base 7 and, at their radially inner end, a slot opening 8. The slot openings 8 are each closed by a slot-closure means 9, so that the stator windings 6 are held in the stator slot 5.

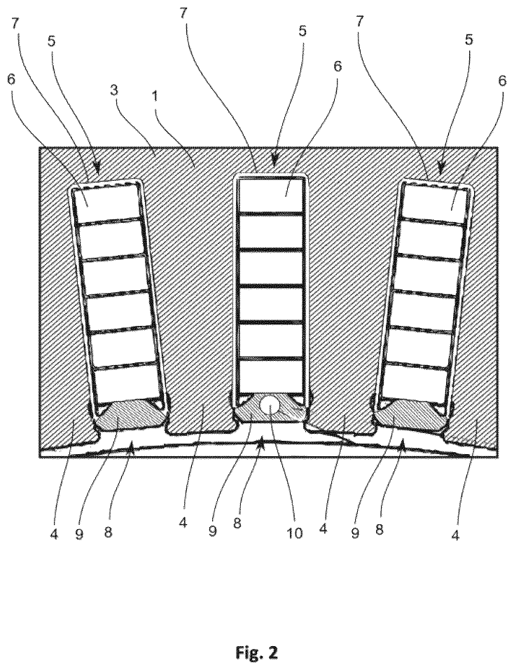

This can also be seen particularly well in FIG. 2, which shows a detailed view of the stator region of a stator slot 5. It can, in particular, be seen here that a temperature sensor 10 is arranged in one of the slot-closure means 9.

In the exemplary embodiment shown, the slot-closure means 9 is made of plastic and the temperature sensor 10 is surrounded by plastic at least in sections, preferably completely. In order to accommodate the temperature sensor 10, the slot-closure means 9 has a sensor channel which is circumferentially closed at least in sections, into which the temperature sensor 10 is inserted and held in the sensor channel 13 by means of a fixing material.

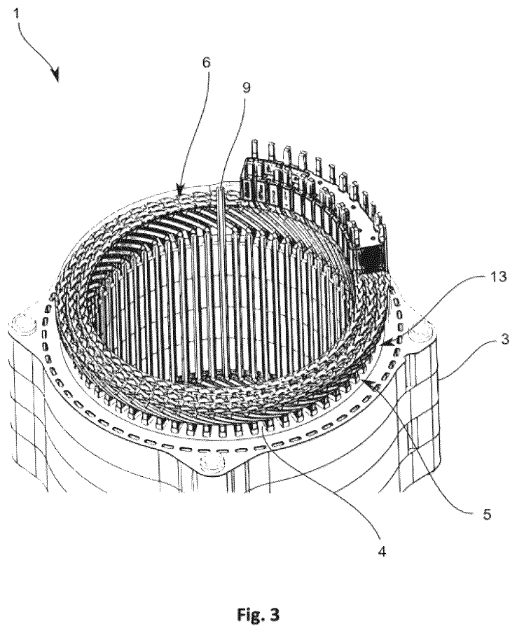

As an alternative to a sensor channel 13, the slot-closure means 9 can also have a (sensor) slot 16, into which the temperature sensor 10 is inserted and held in the (sensor) slot 16 by means of a fixing material. This embodiment is shown in FIGS. 3-6.

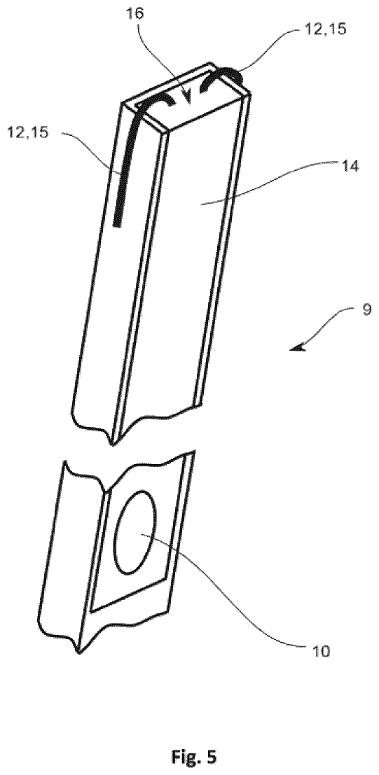

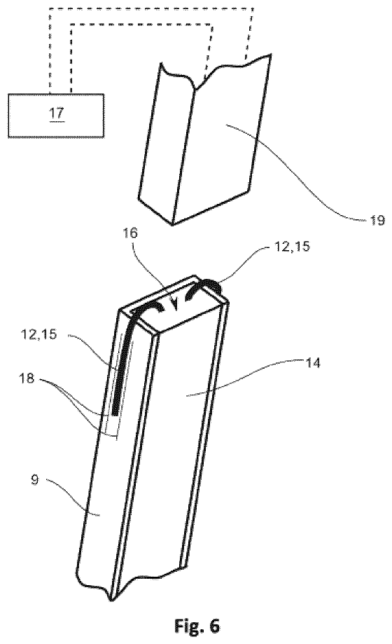

The fixing material shown in FIGS. 5-6 is, for example, a potting compound, in particular a potting compound made of a plastic, and/or an adhesive. In principle, it is also possible that the fixing material is identical to the material of the slot-closure means 9, wherein the fixation of the temperature sensor 10 in and/or on the slot-closure means 9 is realized by applying a forming process to the slot-closure means 9.

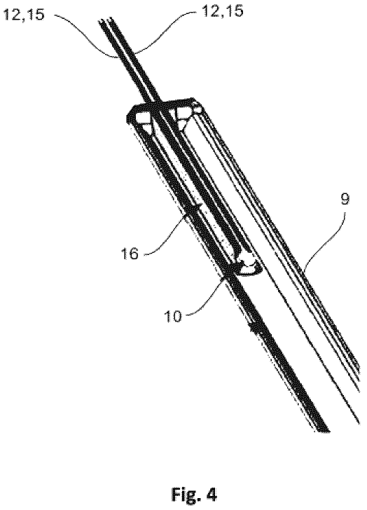

FIG. 3 shows a stator 1 for an electric machine 2, wherein one of the slot openings 8 is closed by a slot-closure means 9, so that the stator windings 6 are held in the stator slot 5 and wherein a temperature sensor 10 is arranged in and/or on the slot-closure means 9, which has at least one electrical conductor 12, by means of which the temperature sensor 10 can be coupled to a control unit 17. Here, the electrical conductor 12 extends substantially axially on and/or through the slot-closure means 9 and projects out of the slot-closure means 9, which can also be easily recognized from the synopsis of FIG. 3 together with FIGS. 4-6.

The slot-closure means 9 provided with a temperature sensor 10 protrudes axially from a winding head 13 formed by the stator windings 6, so that the assembly is particularly simple.

FIG. 4 shows that the slot-closure means 9 has a slot 16 within which the two electrical conductors 12 extend. FIG. 5 shows that these electrical conductors 12 are fixed in and/or on the slot-closure means 9 by means of a potting compound 14. In the embodiments shown, the electrical conductors 12 are each designed as cables 15, which do not have an electrically insulating sheath.

FIG. 5 shows that, in each case, the part of the electrical conductor 12 projecting out of the slot-closure means 9 bears at least in sections against an electrically non-conductive, outer lateral surface 17 of the slot-closure means 9. The lateral surface 17 of the slot-closure means 9 has one guide section 18, in each case, for fixing the part of the electrical conductor 12 projecting out of the slot-closure means 9, which is indicated in FIG. 6. FIG. 6 also shows that, in each case, the part of the electrical conductor 12 projecting out of the slot-closure means 9 can be contacted by means of a plug 19 which can be attached to the slot-closure means 9. In this way, the slot-closure means 9 can be coupled to the control unit 17 of the stator 3.

The disclosure is not limited to the embodiments shown in the figures. The above description is therefore not to be regarded as limiting, but rather as illustrative. The following claims are to be understood as meaning that a stated feature is present in at least one embodiment of the disclosure. This does not exclude the presence of further features. Where the claims and the above description define ‘first’ and ‘second’ features, this designation serves to distinguish between two features of the same type without defining an order of precedence.

### LIST OF REFERENCE SIGNS

1 Stator
2 Electric machine
3 Stator body
4 Stator teeth
5 Stator slots
6 Stator windings
7 Slot base
8 Slot opening
9 Slot-closure means
10 Temperature sensor
12 Electrical conductor
13 Winding head
14 Potting compound
15 Cable
16 Slot
17 Control unit
18 Guide section
19 Plug

1. A stator for an electric machine, comprising a stator body having a plurality of stator teeth arranged in a circumferentially distributed manner and stator slots formed between the stator teeth and extending in the axial direction through the stator body, wherein stator windings are arranged in the stator slots and the stator slots have, along their radial extension at their radially outer end, a slot base and, at their radially inner end, a slot opening, or the stator slots have, along their radial extension at their radially inner end, a slot base and, at their radially outer end, a slot opening, wherein at least one of the slot openings is closed by a respective slot-closure means in each case such that the stator windings are held in the stator slot, wherein a temperature sensor is arranged in and/or on at least one of the slot-closure means and the temperature sensor has at least one electrical conductor, by means of which the temperature sensor can be coupled to a control unit, wherein the electrical conductor extends substantially axially on and/or through the slot-closure means and projects out of the slot-closure means,
wherein the slot-closure means provided with a temperature sensor protrudes axially from a winding head formed by the stator windings.

2. The stator according to claim 1, wherein the at least one electrical conductor is fixed in and/or on the slot-closure means by means of a potting compound.

3. The stator according to claim 1, wherein the at least one electrical conductor comprises a cable.

4. The stator according to claim 3, wherein the cable does not have an electrically insulating sheath.

5. The stator according to claim 1, wherein the slot-closure means has a slot within which the at least one electrical conductor extends.

6. The stator according to claim 1, wherein the part of the at least one electrical conductor projecting out of the slot-closure means bears at least in sections against an outer lateral surface of the slot-closure means.

7. The stator according to claim 6, wherein the lateral surface of the slot-closure means is formed with a guide section for fixing the part of the at least one electrical conductor projecting out of the slot-closure means.

8. The stator according to claim 1, wherein the part of the at least one electrical conductor projecting out of the slot-closure means can be contacted by means of a plug which can be attached to the slot-closure means.

9. A slot-closure means of a stator of an electric machine, comprising:
a temperature sensor arranged in and/or on at least one of the slot-closure means of claim 1 for coupling with a control unit.

10. A temperature measuring arrangement for a stator of an electric machine comprising a control unit, a temperature sensor and the slot-closure means of claim 1, wherein a temperature sensor is arranged in and/or on the slot-closure means for coupling with the control unit.

11. A stator for an electric machine comprising
a stator body including a plurality of stator teeth distributed along the stator body and stator slots formed between the stator teeth and extending in the axial direction through the stator body;
a plurality of stator windings arranged in the stator slots, wherein each stator slot includes a stator base arranged along the radial extension of the stator slot at a first radially end, and a slot opening arranged at a second radially end of the stator slot,
wherein each of the slot openings is closed by a slot-closure such that the stator windings are held in the stator slots; and
a temperature sensor coupled to at least one slot-closure, wherein the temperature sensor includes at least one electrical conductor, wherein the slot-closure protrudes axially from a winding head formed by the stator windings.

12. The stator according to claim 1, wherein the at least one electrical conductor is coupled to the slot-closure by a potting compound.

13. The stator according to claim 1, wherein the at least one electrical conductor comprises a cable.

14. The stator according to claim 3, wherein the cable is sheathless.

15. The stator according to claim 1, wherein the slot-closure includes a slot, wherein the at least one electrical conductor extends within the slot.

16. The stator according to claim 1, wherein a portion of the at least one electrical conductor projecting out of the slot-closure is contacted against an outer lateral surface of the slot-closure.

17. The stator according to claim 16, wherein a lateral surface of the slot-closure is formed with a guide section for fixing the portion of the at least one electrical conductor projecting out of the slot-closure.

18. The stator according to claim 16, wherein the portion of the at least one electrical conductor projecting out of the slot-closure is contacted by a plug attached to the slot-closure.

19. An electric machine comprising
a stator, wherein the stator comprises:
a stator body including a plurality of stator teeth distributed along the stator body and stator slots formed between the stator teeth and extending in the axial direction through the stator body;
a plurality of stator windings arranged in the stator slots, wherein each stator slot includes a stator base arranged along the radial extension of the stator slot at a first radially end, and a slot opening arranged at a second radially end of the stator slot,
wherein each of the slot openings is closed by a slot-closure such that the stator windings are held in the stator slots; and
a temperature sensor coupled to at least one slot-closure, wherein the temperature sensor includes at least one electrical conductor.

20. The electric machine according to claim 19, wherein the slot-closure protrudes axially from a winding head formed by the stator windings.
